(19) United States
(12) Patent Application Publication
(10) Pub. No.: US 2003/0099356 A1
(43) Pub. Date: May 29, 2003

(54) Scrambler of wireless device

(76) Inventors: Shouji Fujino, Tokyo (JP); Hiroyuki Hakoda, Saitama (JP)

Correspondence Address: BROWDY AND NEIMARK, P.L.L.C., 624 NINTH STREET, NW, SUITE 300, WASHINGTON, DC, 20001-5303, US

(21) Appl. No.: 10/018,888

(22) PCT Filed: Mar. 30, 2001
(86) PCT No.: PCT/JP01/02751

(30) Foreign Application Priority Data
Apr. 24, 2000 (JP) 2000-123043

(51) Int. Cl. H04N 7/167

(52) U.S. Cl. 380/236

(57) ABSTRACT

Transmission of an audio signal is performed alternately in a first and a second condition in precisely timed sequence. In the first condition, the audio signal is inverted in frequency spectrum. In the second condition, the audio signal is normal. Due to this, a cryptographic apparatus is improved in security in communication. in a radio communication system linked to a radio network for transmitting an audio signal having been inverted in frequency spectrum to render the signal unintelligible, there are provided: a transmitter-side frequency spectrum inversion/non-inversion circuit including a frequency spectrum inversion circuit; a CPU for generating a control signal; a transmitter-side frequency spectrum inversion/non-inversion change-over switch; and, a sub-carrier oscillator. The CPU controls both the frequency spectrum inversion/non-inversion switch and the sub-carrier transmitter.

### FIELD OF THE INVENTION

The present invention relates to a cryptographic apparatus in a radio communication system, and more particularly to a cryptographic apparatus in a radio communication system, wherein the apparatus is simple in construction and improved in secrecy in radio communication.

### BACKGROUND OF THE INVENTION

In a conventional radio communication system which is linked to other communication systems via a common wireless network, since the wireless network employs a radio wave as a carrier wave, there is a fear that some interlopers eavesdrop on the content of the radio communication. Heretofore, in order to prevent such eavesdropping from occurring in the network, a well-known conventional cryptographic apparatus employs an “audio frequency spectrum inversion” technique in which: a so-called “frequency spectrum inversion” process is performed as to an audio signal; and, thereafter, the audio signal having its frequency spectrum thus inverted is modulated and then transmitted as a radio wave by using a carrier wave. Such conventional cryptographic apparatus may prevent the interlopers from eavesdropping on the content of the radio communication since the interlopers merely catch the audio signal having been subjected to the frequency spectrum inversion process even when they try to catch the content of the communication, wherein the frequency spectrum inversion process renders the content of the communication unintelligible.

In such conventional cryptographic apparatus employs the “audio frequency spectrum inversion” technique: in a transmitter side, an inputted voice frequency spectrum is combined with a sine wave generated in an oscillator to produce a complex wave which is then inverted; and, in a receiver side, the thus inverted signal is normalized using a known sub-carrier. As is clear from above, a cryptographic method employed in the conventional apparatus is simple in process.

More particularly, as shown in FIG. 2, an audio signal collected by and produced in a microphone 31 is amplified in a microphone amplifier 32. The thus amplified audio signal has its waste high-frequency components eliminated in a low-pass filter 33, and is therefore improved in signal-to-noise ratio. Then, the resultant signal is combined with a sine wave of approximately 3 to 5 KHz having been generated in a sub-carrier oscillator 34, and subjected to the frequency spectrum inversion process. The signal thus inverted in frequency spectrum passes through a low-pass filter 35 to eliminate its sub-carrier components, and then combined with a carrier frequency hating been determined by both a CPU 36 and a PLL 37 to produce a complex signal. Such a complex signal is supplied to an FM transmitter circuit 38 and then transmitted through an antenna 39.

On the other hand, in the receiver side, an incoming signal is received by an FM receiver circuit 40, and supplied to a low-pass filter 41 in which the incoming signal has its waste high-frequency components eliminated. After that, the thus-processed signal is then demodulated through combination with the same sine wave as that generated in the sub-carrier oscillator 34 during the above frequency spectrum inversion process. The thus demodulated signal is subsequently supplied to a low-pass filter 42 to have its sub-carrier components eliminated to reproduce the audio signal. Thus reproduced audio signal is then amplified by an AF power amplifier 43 and outputted from a speaker 44 as a voice or sound.

Further, in general, communication performed using the conventional cryptographic apparatus is limited in application to predetermined group members. Consequently, in such a case, a sub-carrier oscillator, which is preset in frequency, is incorporated in the radio communication system.

However, the conventional cryptographic apparatus having the above construction is poor in security, because the interlopers can easily obtain a normal audio signal through a simple demodulation process. More particularly, it is easy for the interlopers to invert again in frequency spectrum the output audio signal to obtain the normal signal when they receive the output audio signal using a demodulator which is simple in construction, because: the output audio signal has passed through the conventional cryptographic apparatus, and therefore subjected to the frequency spectrum inversion process; and, the demodulator is simply constructed of a sub-carrier oscillator, a multiplier, a low-pass filter and the like. Due to this, even when the interlopers can't identify an exact value of the carrier frequency used in the frequency spectrum inversion process, they can obtain a demodulated audio signal, which merely varies in tone level and therefore converted into the original audio signal in a relatively easy manner

Further, in the prior art, it is also proposed to improve the cryptographic apparatus in security by using a technique in which the audio signal has its audible analog frequencies divided into a plurality bands which are individually subjected to the frequency spectrum inversion process, or, by using a technique in which these bands are replaced with each other. However, these techniques require relatively complex signal processing as to the audio signal, which has a received audio signal considerably deteriorated in tone quality. This makes it difficult to keep the radio communication good in quality.

The present invention was made in view of the above problems inherent in the prior art. Consequently, it is an object of the present invention to provide a cryptographic apparatus and method in a radio communication system, wherein the apparatus is simple in construction and improved in secrecy or security in radio communication.

### SUMMARY OF THE INVENTION

The present invention provides a cryptographic apparatus in a radio communication system for having an audio signal subjected to a frequency spectrum inversion process, wherein the audio signal is transmitted through a radio communication network linked to the radio communication system, The cryptographic apparatus comprises a transmitter circuit and a receiver circuit. The transmitter circuit is constructed of: a transmitter-side frequency spectrum inversion/non-inversion circuit including a frequency spectrum inversion circuit; a CPU for generating a control signal; a transmitter-side frequency spectrum inversion/non-inversion change-over switch; and, a sub-carrier oscillator, wherein: the receiver circuit is constructed of: a receiver-side frequency spectrum inversion/non-inversion circuit including a frequency spectrum inversion circuit; a receiver-side frequency spectrum inversion/non-inversion change-over switch; the CPU for generating the control signal, the CPU being used also in the transmitter circuit; and, a sub-carrier oscillator.

In the cryptographic apparatus in the above radio communication system, the audio signal is transmitted in a first condition in which the audio signal has been subjected to the frequency spectrum inversion process, and also transmitted in a second condition in which the audio signal is free from the frequency spectrum inversion process, wherein transmission of the audio signal is performed alternately in the first and the second condition in precisely timed sequence.

### BRIEF DESCRIPTION OF THE DRAWING

FIG. 1 is a block diagram of the cryptographic apparatus of the present invention; and

FIG. 2 is a block diagram of the conventional cryptographic apparatus illustrated in construction.

### BEST MODE FOR CARRYING OUT THE INVENTION

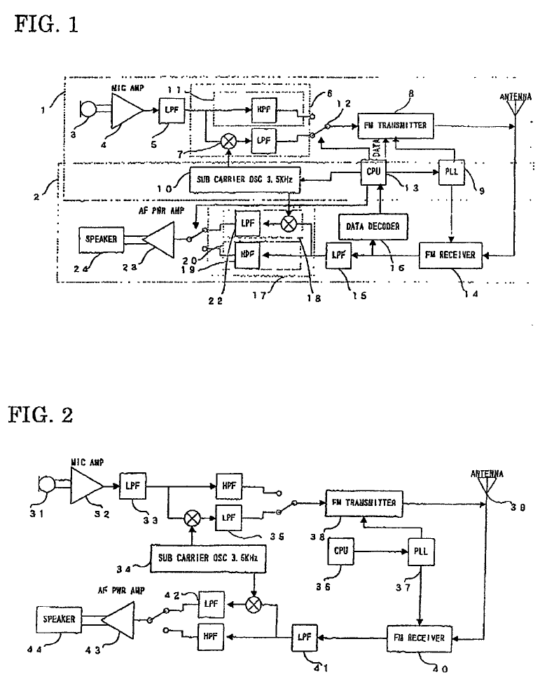

With reference to the accompanying drawings, embodiments of the present invention will be described. FIG. 1 is a block diagram of the cryptographic apparatus according to the present invention, wherein: the reference numeral 1 denotes a transmitter portion; and, the reference numeral 2 denotes a receiver portion.

First, the transmitter portion 1 will be described. In this transmitter portion 1: the reference numeral 3 denotes a microphone; the reference numeral 4 denotes a microphone amplifier; the reference number 5 denotes a low-pass filter for eliminating noise; the reference numeral 6 denotes a frequency spectrum inversion/non-inversion circuit including a frequency spectrum inversion circuit 7; the reference numeral 8 denotes a high-frequency transmission modulator circuit; the reference numeral 9 denotes a PLL for determining a carrier wave; the reference numeral 10 denotes a sub-carrier oscillator; and, the reference numeral 13 denotes a CPU.

An audio signal issued from a microphone 3 is received by a microphone amplifier 4 and amplified. Then, the thus amplified audio signal passes through the low-pass filter 5 to eliminate its waste high-frequency components. Thereafter, the resultant signal is supplied to the frequency spectrum inversion/non-inversion circuit 6. At this time, when the CPU 13 indicates a non-inversion timing of the frequency spectrum of the audio signal, the CPU 13 issues a signal to the frequency spectrum inversion/non-inversion change-over switch 12 to operate the switch 12 in a manner such that the switch 12 permits the audio signal to pass through a non-inversion path 11. As a result, the audio signal, which is not subjected to the frequency spectrum inversion process, is modulated in the high-frequency transmission modulator circuit 8 and transmitted as a radio wave.

On the other hand, when the CPU 13 indicates a frequency spectrum inversion timing of the audio signal having been inputted to the frequency spectrum inversion/non-inversion circuit 6, the CPU 13 issues a signal to the frequency spectrum inversion/non-inversion change-over switch 12 to operate the switch 12 in a manner such that the frequency spectrum inversion process is carried out. As a result, the audio signal, which has been subjected to the frequency spectrum inversion process, is modulated in the high-frequency transmission modulator circuit 8 and transmitted as a radio wave.

Now, the receiver portion 2 will be described, wherein: the reference numeral 14 denotes a high-frequency receiving circuit; the reference numeral 15 denotes a low-pass filter; the reference numeral 16 denotes a data decoder; the reference numeral 17 denotes a frequency spectrum inversion/non-inversion circuit including a frequency spectrum inversion circuit 18; the reference numeral 19 denotes a high-pass filter; the reference numeral 22 denotes a low-pass filter; the reference numeral 23 denotes an AF power amplifier; and, the reference numeral 24 denotes a speaker.

The transmitted radio wave is received by the high-frequency receiving circuit, and demodulated to produce a signal which is supplied to the low-pass filter 15 and then the data decoder 16. In the low-pass filter 15, an audio signal is extracted and inputted to the frequency spectrum inversion/non-inversion circuit 17.

On the other hand, extracted in the data decoder 16 are. timing information for changing-over of the frequency spectrum inversion/non-inversion operation; frequency information of the sub-carrier; and, like information.

When such information is inputted to the CPU 13, the CPU 13 begins to analyze it and produces a control signal which is supplied to each of the sub-carrier oscillator 10 and the frequency spectrum inversion/non-inversion change-over switch 21. Due to this, at a time when the frequency spectrum inversion operation is not conducted, the audio signal passes through the low-pass filter 15 and the high-pass filter 19 to have its noise removed, and then amplified in the AF power amplifier 23. The thus amplified audio signal is issued from the speaker 24.

On the other hand, at a time when the audio signal is subjected to the frequency spectrum inversion process, the audio signal having been subjected to this process is inverted again in the frequency spectrum inversion circuit 18 to reassume its original wave shape. In the low-pass filter 22, noise still not removed in the low-pass filter 15 is removed. After that, the signal thus free from noise is amplified in the AF power amplifier 23, and issued from the speaker 24.

Both the information of synchronization in the inversion/non-inversion process and the information of the sub-carrier frequency in the cryptographic apparatus of the present invention are capable of being transmitted as a digital signal prior to transmission of an audio signal in a radio communication system such as ones of FM modulation type in which the digital signal of MSK modulation type is transmitted. Consequently, such digital signal is highly reliable and easily encrypted. Further, it is possible to realize the modulation/demodulation operation of the present invention and also preparation of a synchronizing signal according to the present invention only by changing the CPU of the radio communication system, and/or by changing software in a microcomputer of the radio communication system.

### Industrial Applicability

The present invention is described above, wherein; the CPU controls: a time when the audio signal is transmitted in a normal condition; a time when the audio signal is subjected to the frequency spectrum inversion process; and, a frequency of the sub-carrier. Due to this, it is extremely hard for the interlopers to intercept and demodulate the audio signal of the cryptographic apparatus of the present invention in the radio communication. In other words, the cryptographic apparatus of the present invention is capable of sufficiently ensuring the radio communication in security.

Even when the interlopers intercept the radio communication by using the conventional demodulating device, they can't understand the content of the radio communication since the conventional demodulating device demodulates only the inverted portion of the audio signal while newly inverts the remaining normal portion of the audio signal, which renders the content of the entire radio communication unintelligible, In case that the interlopers intercept the radio communication without using the demodulating device, they may understand only half the content of the radio communication as a normal voice or sound, which makes it substantially impossible for the interlopers to understand the content of the entire radio communication. Furthermore, it is possible for the cryptographic apparatus of the present invention to vary intervals of the inversion and the non-inversion processes together with the frequency of the sub-carrier each time the radio communication is performed, which further improves the cryptographic apparatus of the present invention in secrecy or security in the radio communication.

1. A cryptographic apparatus in a radio communication system for having an audio signal subjected to a frequency spectrum inversion process, wherein said audio signal is transmitted through a radio communication network linked to said radio communication system, the cryptographic apparatus comprising a transmitter circuit and a receiver circuit, wherein said transmitter circuit is constructed of: a transmitter-side frequency spectrum inversion/non-inversion circuit including a frequency spectrum inversion circuit; a CPU for generating a control signal; a transmitter-side frequency spectrum inversion/non-inversion change-over switch; and, a sub-carrier oscillator, wherein: said receiver circuit is constructed of: a receiver-side frequency spectrum inversion/non-inversion circuit including a frequency spectrum inversion circuit; a receiver-side frequency spectrum inversion/non-inversion change-over switch; said CPU for generating said control signal, said CPU being used also in said transmitter circuit; and, a sub-carrier oscillator.

2. The cryptographic apparatus in the radio communication system as set forth in claim 1, wherein: said audio signal is transmitted in a first condition in which said audio signal has been subjected to said frequency spectrum inversion process, and also transmitted in a second condition in which said audio signal is free from said frequency spectrum inversion process, wherein transmission of said audio signal is performed alternately in said first and said second condition in precisely timed sequence.
